(19) United States
(12) Patent Application Publication
(10) Pub. No.: US 2015/0023518 A1
(43) Pub. Date: Jan. 22, 2015

(54) APPARATUS FOR PROVIDING WIRELESS FUNCTIONALITY TO AN AUDIO PLAYBACK DEVICE

(71) Applicant: Mizco International Inc., Avenel, NJ (US)

(72) Inventor: Maurice Mizrahi, Brooklyn, NY (US)

(21) Appl. No.: 14/338,282

(22) Filed: Jul. 22, 2014

Related U.S. Application Data
(60) Provisional application No. 61/856,826, filed on Jul. 22, 2013.

(51) Int. Cl. H04R 1/06; H04R 1/10

(52) U.S. Cl. CPC H04R 1/06; H04R 1/1091; H04R 2201/107; H04R 2420/03
USPC 381/74

(57) ABSTRACT

A wireless module for providing wireless transmission of audio to an audio playback apparatus, such as a set of headphones or speakers, is provided. The wireless module may include a wireless transceiver configured for receiving an audio stream, an audio output interface configured for sending an audio output stream, and a fastener for fastening the wireless transceiver to the audio playback apparatus. The fastener may be a spring loaded grasping fastener, a magnetic or sticky fastener, a clamping fastener or a clip fastener.

### CLAIM OF PRIORITY

The present Application for Patent claims priority to U.S. Provisional Application No. 61/856,826 entitled “Apparatus for Providing Wireless Functionality to Conventional Headphones”, filed Jul. 22, 2013, which is hereby expressly incorporated by reference.

### TECHNICAL FIELD

The present disclosure relates generally to wireless communication, and more particularly, to wireless streaming audio.

### BACKGROUND

With the proliferation of various audio formats in recent years, users are increasingly relying on portable devices so they can allow users to enjoy music at convenient locations. Despite the portability offered by these devices, the operation of the devices is not always convenient. One major drawback of these devices is the necessity for a user's headphones to be connected or plugged into the device. Typically, in order for a user to listen to music from such a device, the user must wear headphones that are physically connected to the device. Such a configuration is not always ideal. For example, if a user is engaged in sporting activities, the physical connection of the headphones to the device may limit the user's mobility. Moreover, the possible jostling of the headphones during such activities may cause ear cups of the headphones to be dislodged from the user's ears, or cause the headphones to become disconnected from the device. In either case, the user may experience an undesirable interruption.

Another drawback of certain such devices is the need for a user to physically manipulate control buttons on the device in order to control the audio playback. Unfortunately, the need for the user to physically manipulate the controls requires the user to keep the device in relatively close proximity.

Consequently, in view of the above, there is a need for providing wireless functionality to a set of headphones or other audio playback devices.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 illustrates a wireless module for providing wireless functionality to an audio playback device.

FIG. 2 illustrates an exploded view of the wireless module of FIG. 1.

FIG. 3A illustrates a top view of one example of a mounting base for a mount fastener configured for enabling mounting of a wireless module to an audio playback device.

FIG. 3B illustrates a bottom view of the mounting base of FIG. 3A.

FIG. 4 illustrates a mounting base and a mounting strap of a mount fastener.

FIG. 5 illustrates a front perspective view of the wireless module of FIG. 1 mounted onto a headband of a set of headphones using a mount fastener.

FIG. 6 illustrates a side elevation view of the wireless module mounted onto the headband of the set of headphones of FIG. 5.

FIG. 7 illustrates a mount fastener utilized to secure a wireless module to a large sized headband.

FIG. 8 illustrates a mount fastener utilized to secure the wireless module to a small sized headband.

FIG. 9 illustrates a metal plate for mounting a wireless module to an audio playback device using a magnetic or sticky fastener, according to one aspect.

FIG. 10 illustrates the wireless module mounted to an ear cup of a set of headphones using the metal plated of FIG. 9.

FIG. 11 illustrates a metal plate for mounting a wireless module using a magnetic or sticky fastener, according to a second aspect.

FIG. 12 illustrates a clip fastener secured to a bottom panel of a wireless module, according to an aspect.

FIG. 13 illustrates a left side perspective view of the clip fastener of FIG. 12 in an unassembled configuration snapped onto a bottom panel of a wireless module.

FIG. 14 illustrates a right side perspective view of the clip fastener of FIG. 12 in an unassembled configuration snapped onto a bottom panel of a wireless module.

FIG. 15A illustrates a channel mount clip fastener in an assembled configuration.

FIG. 15B illustrates a channel mount clip fastener in an unassembled configuration.

FIG. 16A illustrates a flange mount clip fastener in an unassembled configuration.

FIG. 16B illustrates a side view of a flange mount clip fastener in an assembled configuration.

FIG. 16C illustrates a back view of a flange mount clip fastener in an assembled configuration.

FIG. 17 illustrates a left side perspective view of the clip fastener of FIG. 12 in a partially assembled configuration attached to a wireless module having a strap assembly.

FIG. 18 illustrates a right side perspective view of the clip fastener of FIG. 12 snapped onto a bottom panel of a wireless module having a strap assembly.

FIG. 19 a left side perspective view of a wireless module having a strap assembly.

FIG. 20 illustrates an adjustable strap mount fastener, having a ratchet mechanism, in an open position for mounting a wireless module, according to an aspect.

FIG. 21 illustrates the adjustable strap mount fastener of FIG. 20 in a closed position.

FIG. 22 illustrates an adjustable strap mount fastener having a hook and loop fastener for mounting a wireless module, according to an aspect.

FIG. 23 illustrates the adjustable strap mount fastener of FIG. 22 in a molded angled configuration.

FIG. 24 illustrates a bottom perspective view the wireless module inserted into the adjustable strap mount fastener of FIG. 22.

FIG. 25 illustrates a pivotable adjustable strap mount fastener configured for enabling mounting of the wireless module to large sized headband.

FIG. 26 illustrates the pivotable adjustable strap mount fastener of FIG. 25 configured for enabling mounting of the wireless module to small sized headband.

FIG. 27 illustrates a bottom perspective view of the pivotable adjustable strap mount fastener of FIG. 25.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

According to one aspect, an apparatus for providing wireless transmission of audio content is provided. The apparatus may include a wireless module and a fastener for fastening the wireless module to an audio playback apparatus. The wireless module may include a wireless transceiver configured for receiving an audio stream and an audio output interface configured for sending an audio output stream.

According to one feature, the wireless module may further comprise a housing and and a bottom panel connected to the housing, the bottom panel having one or more male connectors extending horizontally outward from the bottom panel.

According to another feature, the fastener may comprise a mounting base and a longitudinal strap. The mounting base may comprise a bottom surface having a pair of opposing mounting openings and a wall member extending perpendicularly upward from the bottom surface. The wall member may comprise an inner surface and an opposing outer surface; and one or more female connectors located on the inner surface of the wall member and adapted to receive the one or more male connectors of the wireless transceiver. The mounting strap may comprise a longitudinal strap having a first strap end and an opposing second strap end; and a connecting member attached to the second strap end. The first strap end may be adapted to be received within the pair of opposing mounting openings and passed through the connecting member tightening the longitudinal strap. In one non-limiting example, the mounting base may have a generally convex configuration.

According to yet another feature, the fastener may comprise a metal plate adapted to be affixed to the audio playback device; and one or more magnets affixed to the wireless module for securing the wireless module to the audio playback device by a magnetic force. The metal plate may include a notch.

According to yet another feature, the wireless module may further comprise a bottom panel having an outer surface and an opposing inner surface, the wireless transceiver secured to the inner surface of the bottom panel; an internal panel, in electrical communication with the wireless transceiver, the audio output interface secured to the internal panel; and a housing adapted to receive the internal panel and the bottom panel, the bottom panel configured to form a bottom of the housing.

According to yet another feature, the wireless module may further comprise a user interface, in electrical communication with the audio output interface, for enabling audio playback functionality, wherein the user interface comprises a plurality of buttons. The user interface may be located on an outer surface of the housing. The user interface may be a tactile switch.

According to yet another feature, the audio playback device may be a set of headphones.

According to another aspect, an apparatus for providing wireless transmission of audio content is provided. The apparatus may comprise a wireless module and a fastener for fastening the housing to an audio playback apparatus. The wireless module may include a bottom panel having an outer surface and an opposing inner surface; a wireless transceiver, secured to the inner surface of the bottom panel, configured for receiving an audio stream; an internal panel, in electrical communication with the wireless transceiver, having an audio output interface configured for sending an audio output stream; and a housing adapted to receive the internal panel and the bottom panel, the bottom panel configured to form a bottom of the housing.

According to one feature, the bottom panel of the housing includes one or more male connectors extending horizontally outward from the bottom panel.

According to another feature, the fastener may comprise a mounting base and a longitudinal strap. The mounting base may comprise a bottom surface having a pair of opposing mounting openings and a wall member extending perpendicularly upward from the bottom surface. The wall member may comprise an inner surface and an opposing outer surface; and one or more female connectors located on the inner surface of the wall member and adapted to receive the one or more male connectors of the wireless transceiver. The mounting strap may comprise a longitudinal strap having a first strap end and an opposing second strap end; and a connecting member attached to the second strap end. The first strap end may be adapted to be received within the pair of opposing mounting openings and passed through the connecting member tightening the longitudinal strap. In one non-limiting example, the mounting base may have a generally convex configuration.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. In the context of the present specification, when an element is referred to as being “on” another element, it can be directly on the other element or be indirectly on the other element with one or more intervening elements interposed therebetween. Also, in the context of the present specification, when an element is referred to as being “connected” or “coupled” to another element, it can be directly connected or coupled to the other element or be indirectly connected or coupled to the other element with one or more intervening elements interposed therebetween. Like reference numerals designate like elements throughout the specification.

In the following description, certain terminology is used to describe certain features of one or more embodiments. The term “audio playback apparatus” may refer to any type of output device configured to transmit audio information to one or more speakers, e.g., in a set of headphones, in a car, or any other desired destination of the audio information. The term “hole” may refer to any opening through a structure and/or component or a hollowed-out place in a structure and/or component, including apertures, bores, cavities, chambers, grooves, notches, passages, slits and slots. The term “protrusion” may refer to objects or parts projecting in an outward or upward manner from a structure and/or component. The term “attaching member” may refer to a hook, clasp, carabiner or any other type of device that may be used for attaching items together.

### Overview

One or more embodiments of the present disclosure are directed to wireless modules for providing wireless transmission of audio content to an audio playback apparatus, such as a set of headphones or speakers. The wireless module may include a wireless transceiver configured for receiving an audio stream, an audio output interface configured for sending an audio output stream and a fastener for fastening the wireless transceiver to the audio playback apparatus. According to one aspect, the fastener may be a mount fastener having a convex mounting base with a pair of opposing mount openings adapted to receive a mounting strap which may be used to hold the mounting base to a headband of a set of headphones. According to another aspect, the fastener may include a metal plate affixed to an ear cup of a set of headphones and one or more magnets affixed to the wireless module for securing the wireless module to the ear cup by a magnetic force. According to yet another aspect, the fastener may be a clip fastener having a clip that may be configured to flex and clip onto a headband of a set of headphones, a belt of a user or any other object that may be used to mount the wireless module. According to yet another aspect, the fastener may be and adjustable strap mount fastener configured to wrap around a headband of a set of headphones.

### Wireless Module

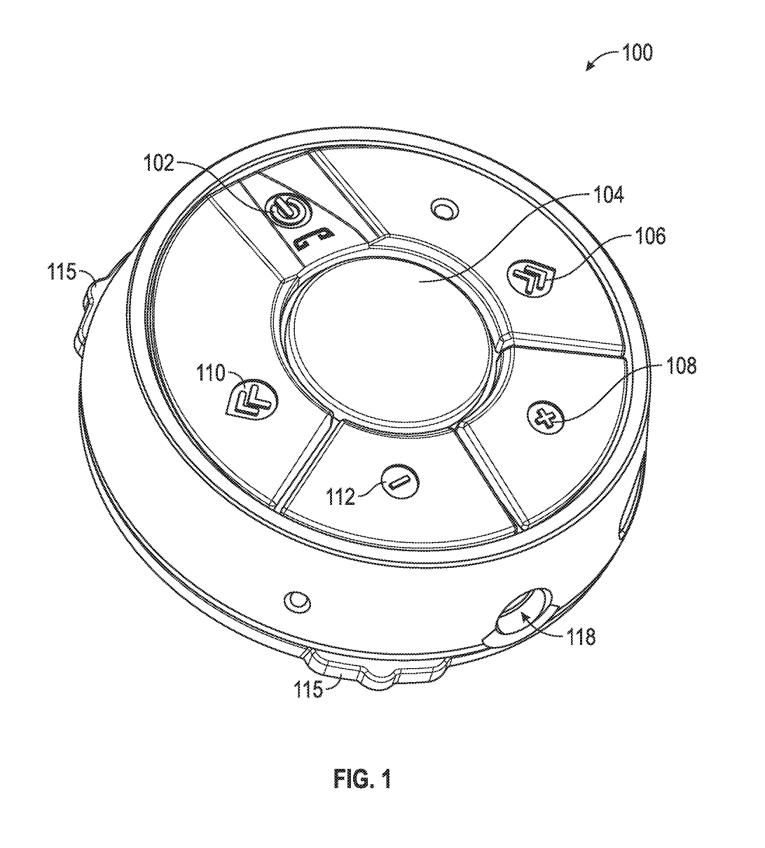

FIG. 1 illustrates a wireless module 100 for securing to an audio playback device. In various examples within the scope of the present disclosure, the wireless module 100 may be configured in accordance with one or more suitable wireless communication protocols, including but not limited to wireless wide area network (WWAN) communication protocols or wireless personal area network (WPAN) communication protocols. As one non-limiting example, the wireless module 100 may be configured according to Bluetooth communication protocols, e.g., as defined by the Bluetooth Special Interest Group, whose standards are publically available. In the disclosure that follows, the wireless module 100 may be referred to as a Bluetooth module 100. However, those of ordinary skill in the art will comprehend that this nomenclature is merely for convenience, and within the scope of the present disclosure, the wireless module 100 may utilize any suitable wireless communication protocol.

In one example, the wireless module 100 may include a Bluetooth transceiver circuit configured to receive a wireless transmission, e.g., including audio information, from one or more external Bluetooth transceiver circuits (not illustrated). As one non-limiting example, a personal computer that includes a Bluetooth transceiver may be configured to stream audio data, stored in its hard drive, to the wireless or Bluetooth module 100, such that the wireless module 100 may receive and enable playback of the audio stream as described below. Of course, any source of a wireless stream may be utilized within the scope of the present disclosure.

As shown in FIG. 1, the wireless module 100 may include a user interface, such as a plurality of control buttons or switches (such as tactile switches), for enabling various functionality generally desired for audio playback including, but not limited to, a power button 102, a play/pause button 104, a forward track button 106, a next track button 108, a reverse track button 110 and a previous track button 112. According to one example, a user may manually depress the buttons and/or switches for operation of their respective functions. Of course, this is merely one example for illustrative purposes, and any suitable user interface (or no user interface) may be included on a particular implementation within the scope of the present disclosure. In an example where the user interface is included, use of the user interface may cause the Bluetooth transceiver within the wireless or Bluetooth module 100 to transmit control information to the external Bluetooth transceiver circuit (not illustrated) (e.g., the source of the audio data stream), to enable control of the playback of the audio stream. Additionally, the plurality of buttons and/or switches may be used as tactile reference markers to assist the user with proper alignment of the wireless module 100 when mounting the wireless module to a set of headphones or other the audio playback device.

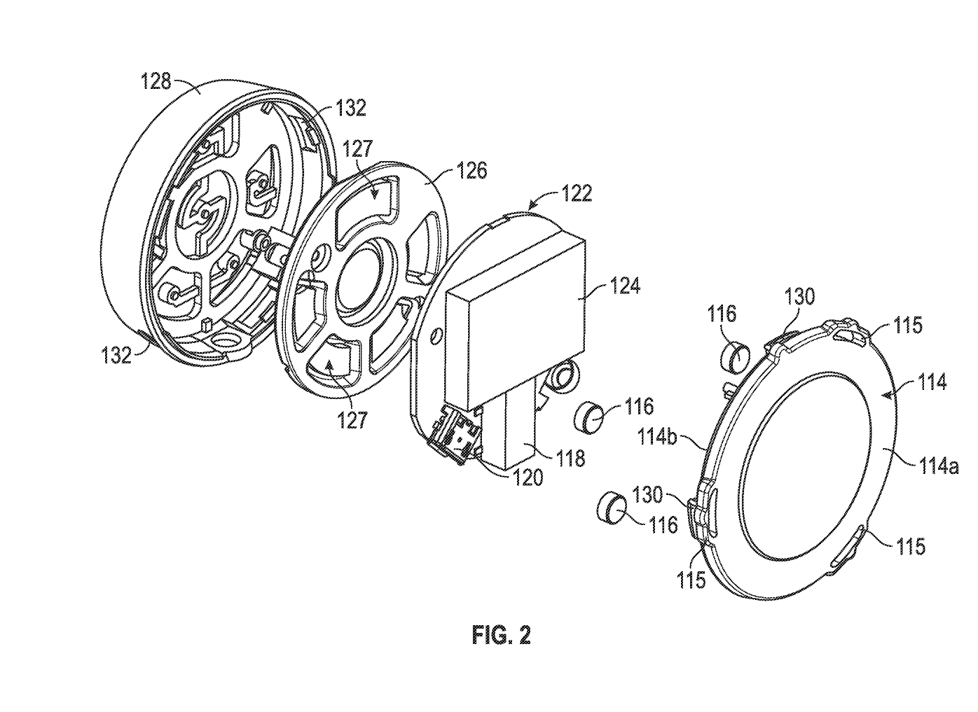

FIG. 2 illustrates an exploded view of the wireless module 100 of FIG. 1. As shown, the wireless module 100 may include a bottom panel 114, having an outer surface 114a and an opposing inner surface 114b connected by a side surface. According to one example, the bottom panel 114 may have a generally circular configuration and include one or more male connectors 115 extending outwardly from the side surface. The one or more male connectors 115 may be configured to be received within one or more female connectors 208 of the mounting base 200 forming a bayonet mount, as described in further detail below.

According to one example, one or more magnets may be 116 located around the perimeter of the bottom panel 114, as described in further detail below, for retaining the wireless module 100 to an audio playback device, such as a set of headphones. A circuit board, having wireless circuitry, may be located on the inner surface 114b of the bottom panel 114. The circuit board may be in electrical communication with an audio cable interface 118 and a data/charging interface 120 located on an internal panel 122. In one example, the audio cable interface 118 may be configured to accept a standard 3 5mm stereo headphone jack, although any suitable interface for enabling the connection of any size or configuration audio cable (or no audio cable interface) may be included in a particular implementation. When a female 3.5 mm stereo headphone interface is included, a user may be enabled to plug a male 3.5 mm headphone jack into the audio cable interface 118.

In some examples, the audio cable interface 118 may provide an audio output signal, which may or may not be amplified internal to the wireless module 100. Here, the audio cable interface 118 may be enabled to electrically couple the wireless module 100 to an output device (not illustrated), to transmit audio information to one or more speakers, e.g., in a set of headphones, in a car, or any other desired destination of the audio information.

In one example, the data/charging interface 120 may be configured to accept a standard micro-USB or mini-USB jack, although any suitable interface for enabling the connection of any size or configuration data/charging cable (or no data/charging interface) may be included in a particular implementation. When a micro-USB data/charging interface 120 is included, a user may be enabled to plug a male micro-USB jack into the data/charging interface 120 to provide power to charge a battery 124 internal to the wireless module 100, to provide active power for operation of the wireless module 100, and/or for single-direction or bi-directional data communication with the wireless module 100.

In one example, the wireless module 100 may include a switch panel 126 having a plurality of openings 127 in alignment the power button 102, play/pause button 104, forward track button 106, next track button 108, reverse track button 110 and previous track button 112 of the user interface. When a user presses down on one of the buttons 102-112 on the user interface, the bottom of the pressed button may extend through the corresponding opening 127 in the switch panel 126 allowing the bottom of the button to come into electrical contact with circuitry (not shown) located on the internal panel 122 as is known in the art. The circuitry (not shown) may be used for controlling and/or operating the power button 102, play/pause button 104, forward track button 106, next track button 108, reverse track button 110 and previous track button 112 of the user interface.

In one example, a foam ring (not shown) having a generally circular configuration, may be located between the switch panel 126 and the internal panel 122 to provide cushioning when a user depresses any of the buttons on the user interface, i.e. the power button 102, play/pause button 104, forward track button 106, next track button 108, reverse track button 110 and previous track button 112. An outer ring or housing 128 may be placed over the switch panel 126, the foam ring (not shown) and the internal panel 122; and secured to the bottom panel 114 forming the wireless module 100.

According to one embodiment, one or more protrusions 130 may extend perpendicularly outward from the inner surface 114b of the bottom panel 114 and adapted to be received or inserted into one or more corresponding holes 132 in the outer ring/housing 128 securing the outer ring/housing 128 to the bottom panel 114.

According to some aspects of the present disclosure, the wireless module 100 may be configured to be mounted onto audio playback, including but not limited to a set of headphones, a car stereo including an “AUX” (auxiliary) media input jack, a home stereo including a media input, or any other suitable apparatus for audio playback.

### Bayonet Mount Fastener

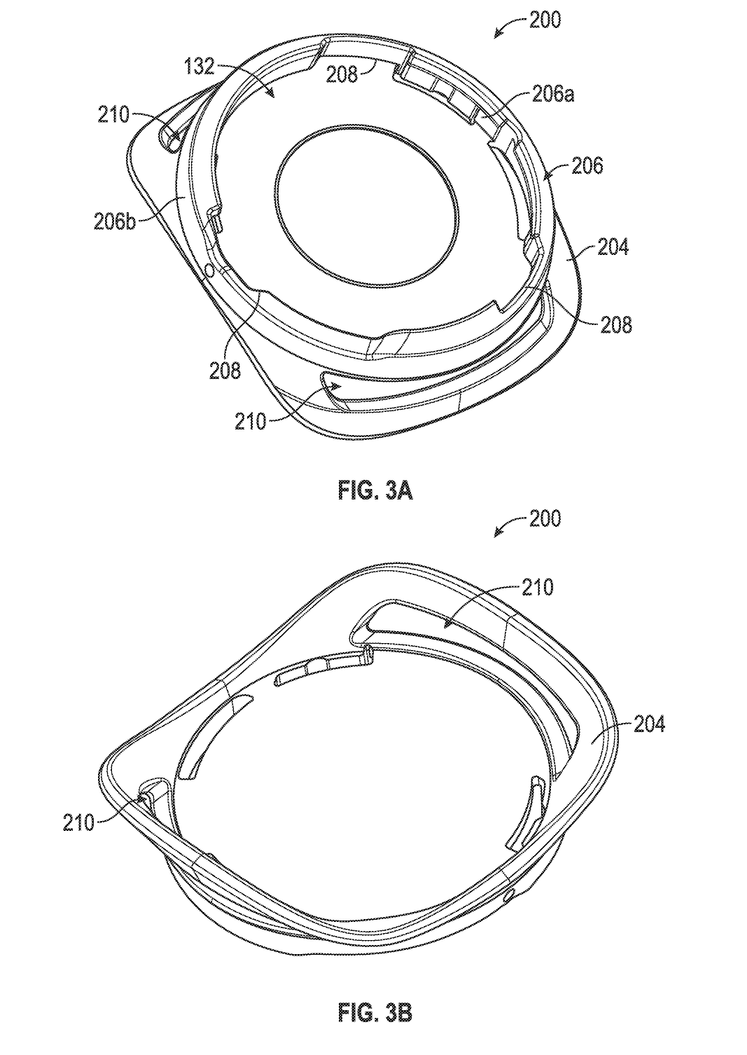

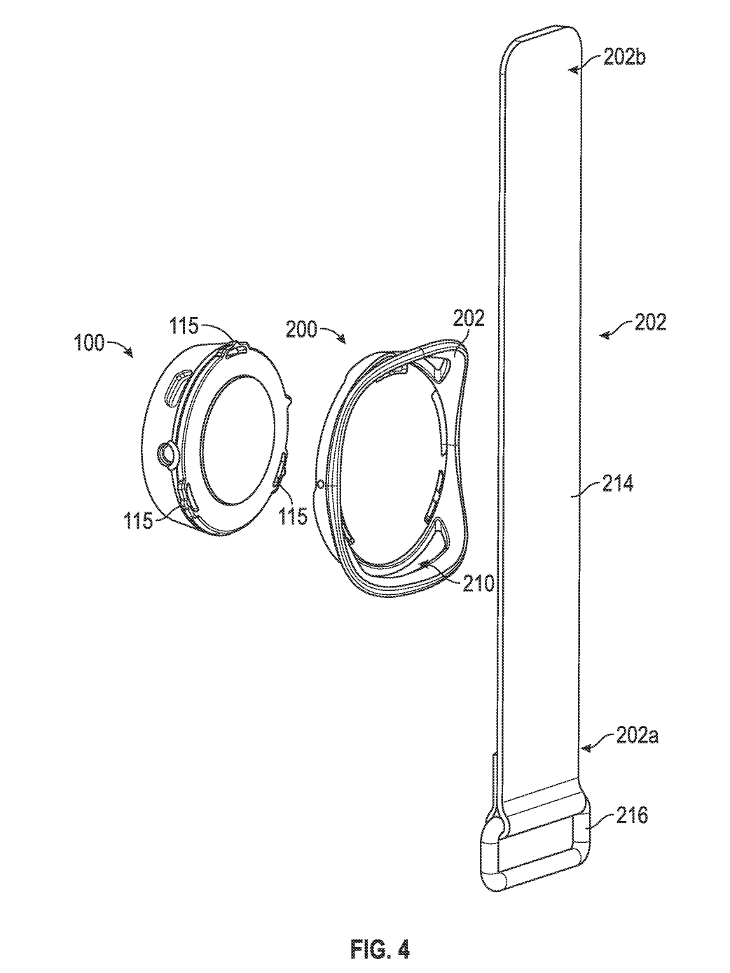

In one example, the wireless module 100 may be configured to utilize a bayonet mount fastener for mounting the wireless module to the audio playback device. The bayonet mount fastener may include a mounting base 200 and a mounting strap 202. FIGS. 3A and 3B illustrate top view and bottom views, respectively, of one example of a mounting base 200 configured for enabling mounting of a wireless module to an audio playback device, such as a set of headphones, as described below. FIG. 4 illustrates the mounting base 200 and the mounting strap 202 adjacent to the wireless module of FIG. 1.

In various examples within the scope of the present disclosure, the mounting base 200 may include a bottom surface 204 and a wall member 206, having a generally circular configuration, connected to and extending perpendicularly upward from the bottom surface 204 forming a retaining ring within the bottom surface 204 and adapted to receive the wireless module 100. In one example, the wall member may be integrally connected to the bottom surface 204 of the mounting base 200. Although the wall member 206 is shown having a generally circular configuration, this is by way of example only and the wall member 206 may be shaped and sized to receive the wireless module 100. Although the wireless module is shown as circular, this is by way of illustration only and the wireless module may take any shape.

The wall member 206 may have an inner surface 206a and an opposing outer surface 206b. One or more female connectors 208 may be located on the inner surface 206a of the wall member 206 and adapted to receive one or more male connectors 115 of the wireless module 100 when the wireless module 100 is placed or inserted into the mounting base 200. After the wireless module 100 has been placed or inserted into the mounting base 200, the wireless module 100 may be rotated or twisted until it is no longer free to rotate. Rotating or twisting the wireless module 100 when in the mounting base 200 causes the one or more male connectors 115 to slide or move within the one or more female connectors 208 locking the wireless module 100 to the mounting base 200. In other words, a bayonet mount may be utilized to secure the wireless module to the mounting base 200.

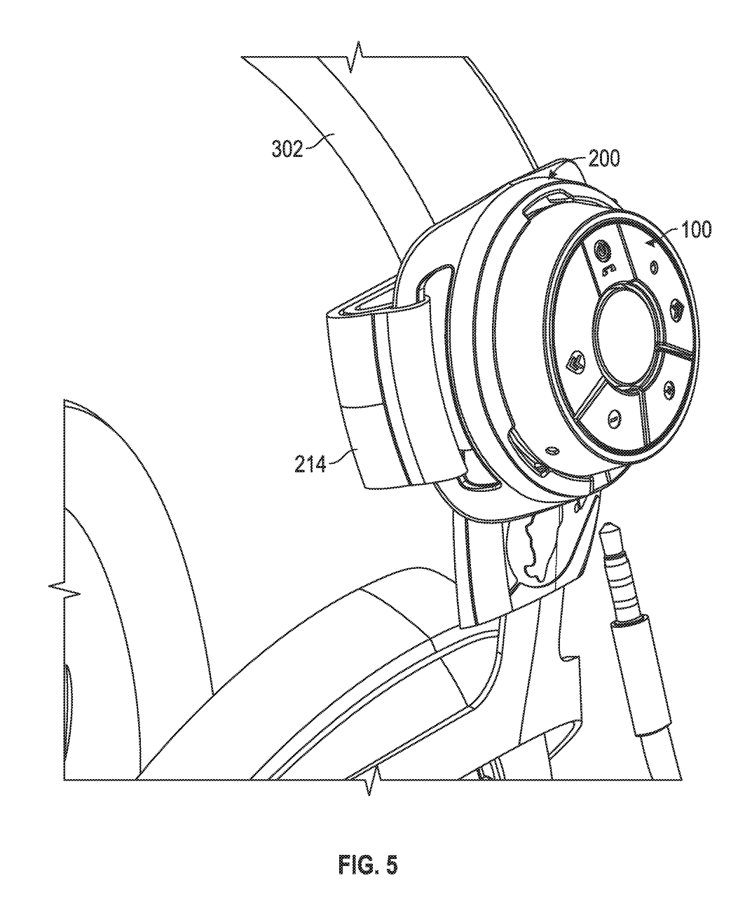

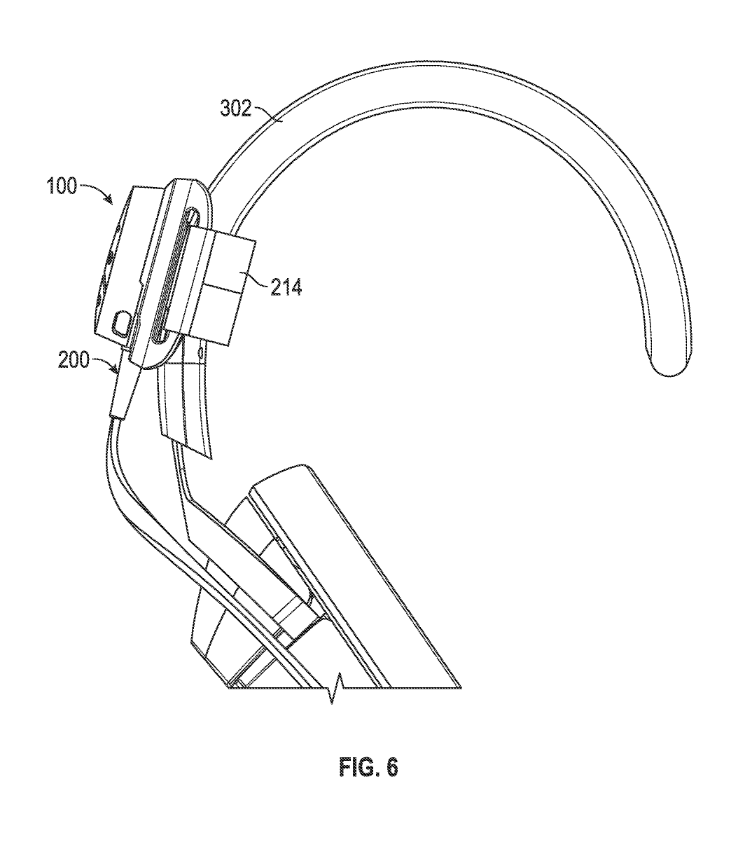

FIG. 5 illustrates a front perspective view of the wireless module 100 of FIG. 1 mounted onto a headband 302 of a set of headphones 300 utilizing the mounting base 200 (or bayonet mount fastener) as described above. FIG. 6 illustrates a side elevation view of the wireless module 100 mounted onto the headband of the set of headphones of FIG. 5.

According to one example, the bottom surface 204 of the mounting base 200 may have a generally square or rectangular shaped configuration. Furthermore, the mounting base 200 may have a generally convex surface adapted to conform to the shape of the headband 302 of the set of headphones.

According to one example, the mounting base 200 may include a pair of opposing mounting openings 210 adapted to receive the mounting strap 202 which may be used to secure the mounting base 200 to the headband 302. As shown, the mounting strap 202 may include a longitudinal strap 214, having a first strap end 202a and a second strap end 202b, secured to a connecting member 216, such as a ring or other connecting or attaching means known in the art. The first strap end 202a may pass through the connecting member 216 and then may be reverse folded, or doubled-back on itself, securing the first strap end 202a to the connecting member 216.

To secure the mounting base 200 to the headband 302, the mounting base 200 may be placed against the headband 302 and the second strap end 202b passed through the pair of opposing mounting openings 210. Next, the second strap end 202b may be passed (or pulled) through the connecting member 216 and folded over upon the connecting member 216 to secure the mounting base 200 to the headband 302. According to one example, the longitudinal strap 214 may include a hook and loop fastener allowing the longitudinal strap 214 to be easily adjusted for attaching to a various sized headbands.

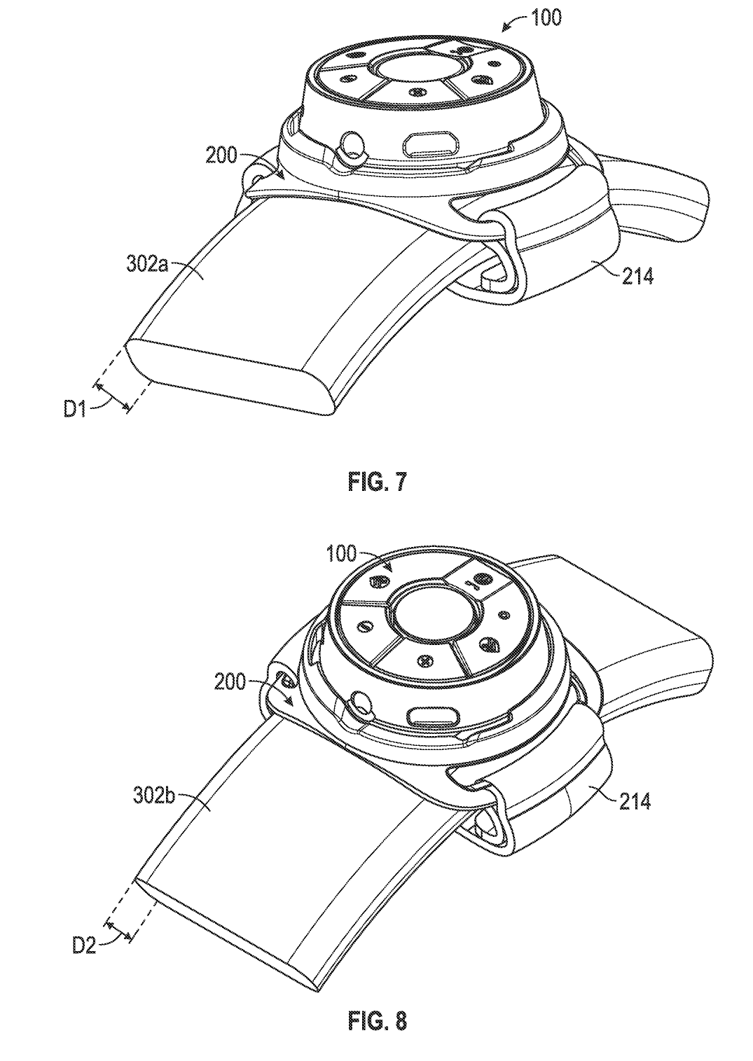

For example, FIG. 7 illustrates a mounting base 200 utilized to secure a wireless module 100 to a large sized headband 302a, and FIG. 8 illustrates a mounting base 200 utilized to secure the wireless module 100 to a small sized headband 302b. As shown, the large headband 302a may have a thickness D1 and the small headband may have a thickness D2, where D2 is less than D1 (i.e. D2<D1). Those of ordinary skill in the art will recognize that these two sizes or thicknesses of headbands 302 are merely illustrative in nature, and a mounting base 200 within the scope of the present disclosure may be enabled to attach to a large range of headband sizes (or thicknesses) not limited to the sizes of the large headband 302a and the small headband 302b.

### Magnetic or Sticky Fastener

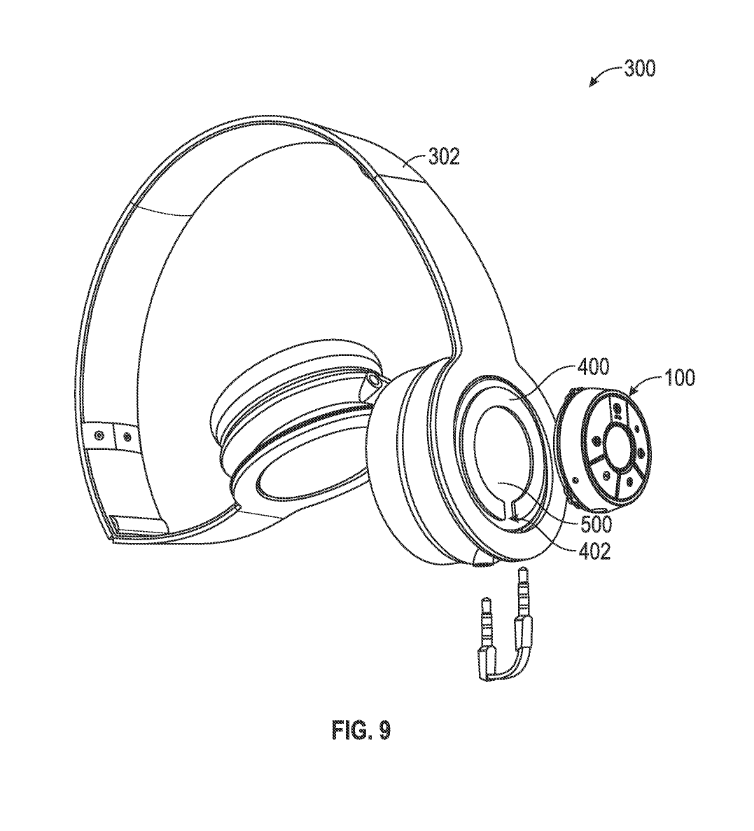

As another example, the wireless module 100 may be configured to utilize a magnetic or sticky fastener 400 for mounting the wireless module 100. Utilizing the metal plate 400 allows a user to mount or remove the wireless module 100 easily. FIGS. 9 and 10 illustrate one example of using a magnetic or sticky fastener to mount a metal plate 400 according to an aspect of the disclosure. In the illustrated example, the metal plate 400 (e.g., a ferromagnetic metal, e.g., steel) may be generally ring-shaped and may be fastened to the ear cup 500 of a set of headphones by utilizing any suitable means, e.g., two-sided tape, glue, adhesive, one or more screws, etc. By utilizing the metal plate 400, the wireless module 100 may be fastened to the ear cup 500 of the set of headphones by means of one or more magnets 116.

For example, as seen in FIG. 2, the outer surface 110a of the bottom panel 100 of the wireless module 100 as illustrated includes three (3) cylindrically shaped magnets 116, such as rare earth magnets. Of course, the inclusion of the magnets in the wireless module 100 is optional, and may or may not be included in a particular implementation. However, in the illustrated example of FIG. 2, the three (3) magnets 116 may be contained mostly or entirely internal to the wireless module 100, such that the wireless module 100 may be fastened utilizing any suitable fastener, including but not limited to the magnetic fastener 400 described herein. Although three (3) magnets 116 are shown, this is by way of example only and more than three (3) magnets or less than three (3) magnets may be utilized.

Returning to FIGS. 9 and 10, it can be seen that the wireless module 100 as illustrated may be easily fastened to the ear cup 500 by placing the wireless module 100 onto the metal plate 400, such that the magnets 116 secure the wireless module 100 onto the metal plate.

In the illustration of FIG. 9, the metal plate of the magnetic fastener 400 is largely ring shaped, but includes a notch or opening 402. This notch 402 is optional, and may be included for alignment of the wireless module 100, for making space for a feature on the bottom of the wireless module 100, or for any other suitable purpose.

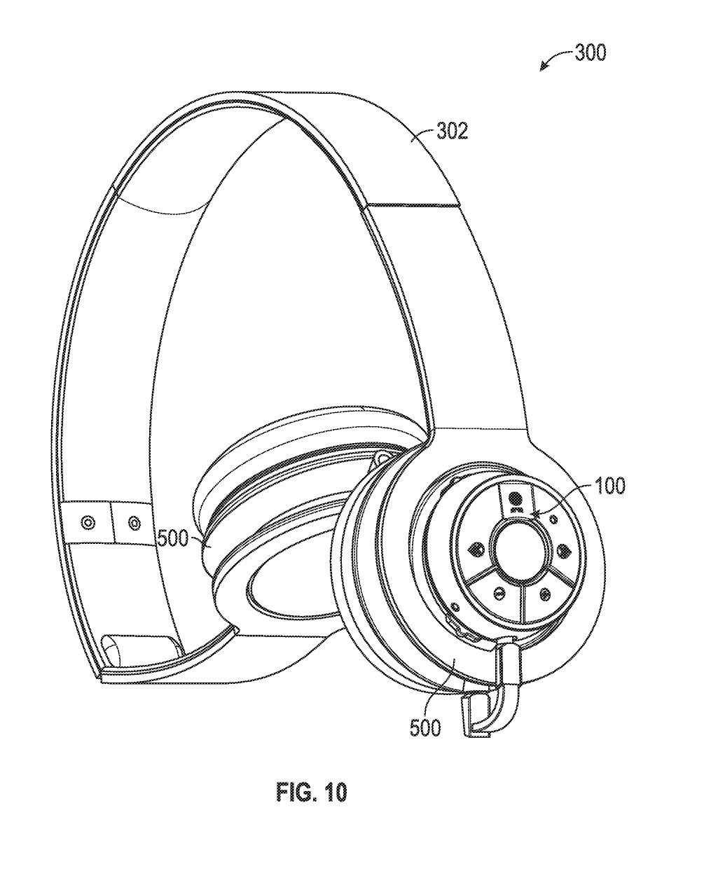

FIG. 11 illustrates another example of a metal plate 600 mounted to an ear cup of a set of headphones using a magnetic or sticky fastener, this example including the notch described above. Furthermore, as seen in FIG. 11, the wireless module 100, while it may function in the same or a similar way, has a modified appearance and includes a hard-wired audio connector cable 602 with a male audio jack 604, rather than the female audio interface described above. Those of ordinary skill in the art will comprehend that, as described herein, the wireless module 100 may take the illustrated configurations or other configurations within the scope of the present disclosure.

### Clip Fastener

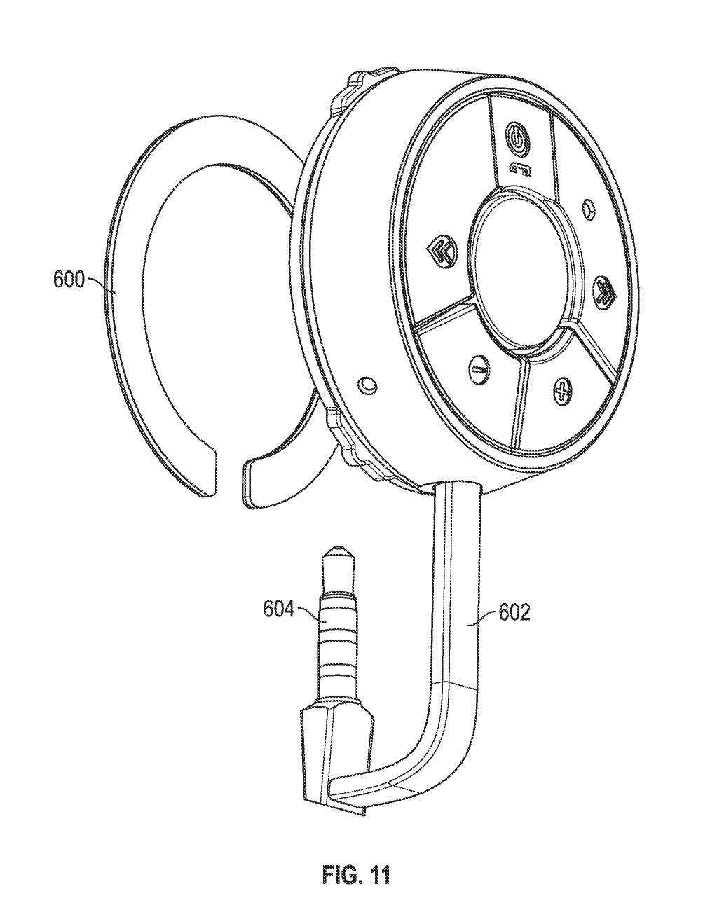

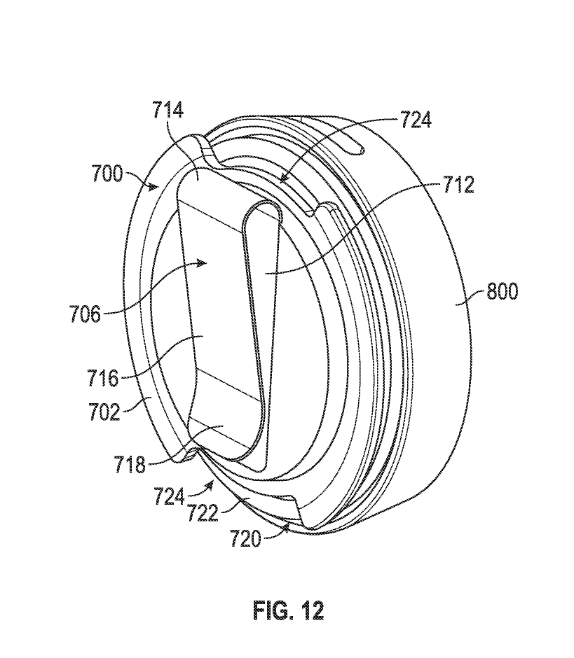

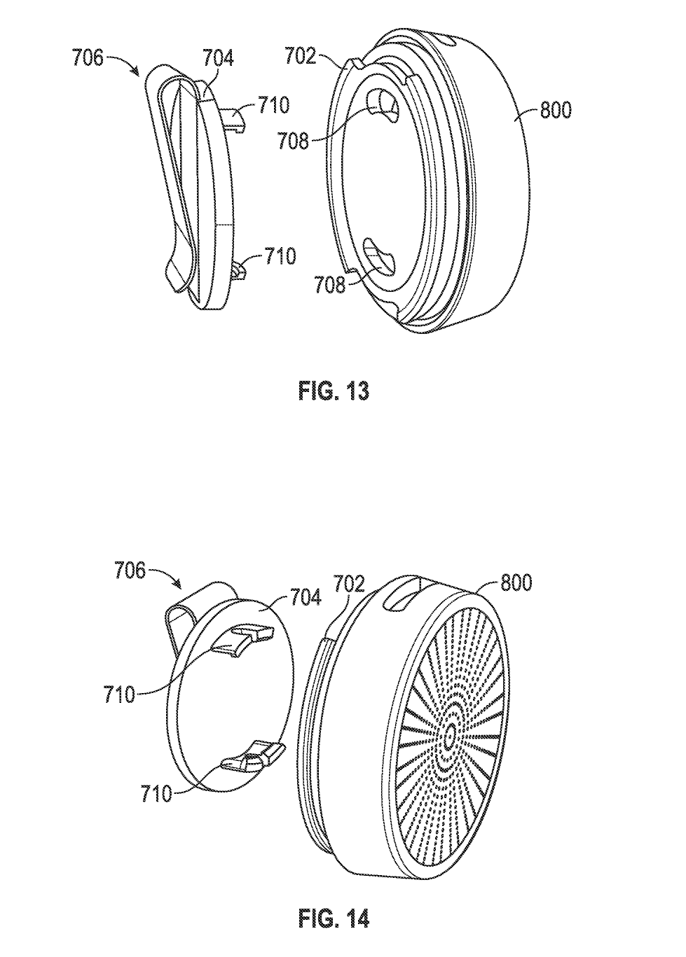

In another example, a wireless module 800 may utilize a clip fastener 700 for mounting. FIG. 12 illustrates a clip fastener 700 secured to a bottom panel of the wireless module 800, according to an aspect. FIG. 13 illustrates a left side perspective view of the clip fastener of FIG. 12 snapped onto a bottom panel of a wireless module. FIG. 14 illustrates a right side perspective view of the clip fastener of FIG. 12 snapped onto a bottom panel of a wireless module. The following discussion refers interchangeably to FIGS. 12-14. Although the outer appearance of the wireless module 800 in FIGS. 12-14 is different than the wireless module 100 in FIGS. 1-11, it may function in the same or similar way.

As shown, the clip fastener 700 may comprise a first attachment member 702, a second attachment member 704 and a clip 706. Both the first attachment member 702 and the second attachment member 704 may have a first side surface and an opposing second side surface. In one non-limiting example, the first side surface of the first attachment member 702 may be attached or secured to the bottom panel of the wireless module 800 using a magnetic or sticky fastener, as described above, or by any other attachment means known in the art.

The second side surface of the first attachment member 702 may include one or more openings 708. The first side surface of the second attachment member 704 may include one or more protrusions 710 extending perpendicularly outward and adapted to be received within the one or more openings 708 on the second side surface of the first attachment member 702. In one non-limiting example, the one or more protrusions 710 may have a generally “L” shape. When the one or more protrusions 710 are inserted into the one or more openings 708, the one or more protrusions 710 may flex outwards and then return to their original position causing the L-shaped end of the one or more protrusions 710 to catch on the first side surface of the first attachment member 702 securing the first attachment member 702 and the second attachment member 704 together.

The second side surface of the second attachment member 704 may include the clip 706 which may include a clip body 712 extending to a bend portion 714 and a clip arm 716 extending back along the clip body 712 from the bend portion 714. The clip arm 716 may include a spring clip 718 formed to bias against the clip body 712. In use, an object or objects are inserted between clip arm 716 and the clip body 712. In one non-limiting example, the object may be a headband of a set of headphones, a belt or other clothing item allowing a user to attach or mount the wireless module. The spring clip 718 may act to hold the object or objects between clip arm 716 and the clip body 712. Those skilled in the art will appreciate that other types of clips and biasing mechanisms may also be used to hold an object or objects between clip arm 716 and the clip body 712.

Additionally, a gap 720 may be located between the first attachment member 702 and the bottom panel of the wireless module 800 allowing wires or cord 722 (for example from a set of headphones) to be spooled. In one non-limiting example, the first attachment member 702 may include a pair of opposing notches 722 allowing for easy access to the spooled cord 720.

### Channel Mount Clip Fastener

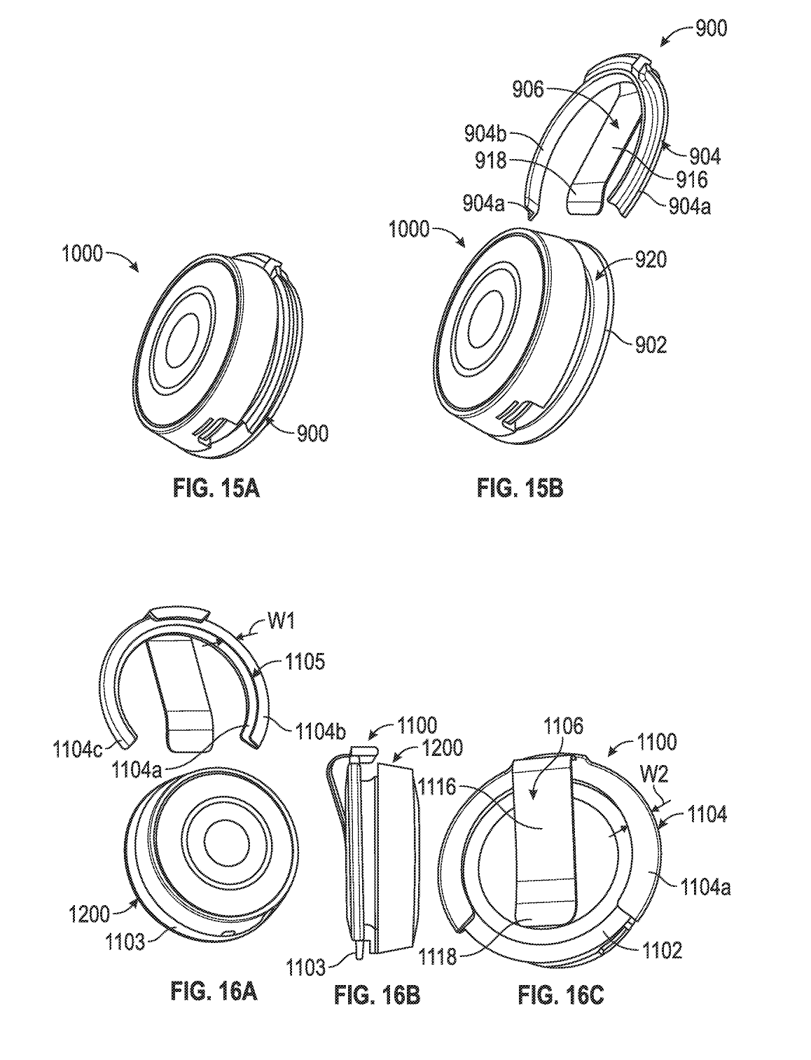

Turning to FIG. 15 (including FIGS. 15A-15B), a channel mount clip fastener 900 according to another example of the present disclosure is provided. FIG. 15A illustrates a channel mount clip fastener in an assembled configuration. FIG. 15B illustrates a channel mount clip fastener in an unassembled configuration. Although the outer appearance of the wireless module 1000 in FIG. 15 is different than the wireless module 100 in FIGS. 1-11, it may function in the same or similar way. Similar to the clip fastener 700 of FIGS. 12-14, the channel mount clip fastener 900 of FIG. 15 comprises a first attachment member 902, a second attachment member 904 and a clip 906.

The first attachment member 902 may have a first side surface and an opposing second side surface. In one non-limiting example, the first side surface of the first attachment member 902 may be attached or secured to the bottom panel of the wireless module 1000 using a magnetic or sticky fastener, as described above, or by any other attachment means known in the art.

The second attachment member 904 may have a generally semi-circular configuration and include a bottom wall member 904a and a side wall member 904b integrally connected and extending substantially perpendicular to the bottom wall member 904a forming a L-shape. In one example, the second attachment member 904 may be sized to be received within a gap 920 formed between the first attachment member 902 and the bottom panel of the wireless module 1000. The clip 906, detachably or integrally connected to the second attachment member 904, may include a clip arm 916 extending downwardly along the first attachment member 904 when the clip fastener 900 is in an assembled configuration. The clip arm 916 may include a spring clip 918 formed to bias against the first attachment member 902. In use, an object or objects are inserted between clip arm 916 and the first attachment member 902. In one non-limiting example, the object may be a headband of a set of headphones, a belt or other clothing item allowing a user to attach or mount the wireless module. The spring clip 918 may act to hold the object or objects between clip arm 916 and the first attachment member 902. Those skilled in the art will appreciate that other types of clips and biasing mechanisms may also be used to hold an object or objects between clip arm 916 and the first attachment member 902.

### Flange Mount Clip Fastener

Turning to FIG. 16 (including FIGS. 16A-16C), a flange mount clip fastener 900 according to another example of the present disclosure is provided. FIG. 16A illustrates a flange mount clip fastener 1100 in an unassembled configuration. FIGS. 16B illustrates a side view of a flange mount clip fastener 1100 in an assembled configuration. FIG. 16C illustrates a back view of a flange mount clip fastener 1100 in an assembled configuration. Although the outer appearance of the wireless module 1200 in FIG. 16 is different than the wireless module 100 in FIGS. 1-11, it may function in the same or similar way. Similar to the clip fastener 900 of FIG. 15, the flange mount clip fastener 1100 of FIG. 16 comprises a first attachment member 1102, a second attachment member 1104 and a clip 1106.

The first attachment member 1102 may have a first side surface and an opposing second side surface. In one non-limiting example, the first side surface of the first attachment member 1102 may be attached or secured to the bottom panel of the wireless module 1200 using a magnetic or sticky fastener, as described above, or by any other attachment means known in the art.

The first attachment member 1102 may have a diameter larger than the bottom panel of the wireless module 1200 forming a flange 1113 which may be adapted to receive the second attachment member 1104, as described below.

The second attachment member 1104 may have a generally semi-circular configuration and include an upper wall member 1104a and a lower wall member 1104b integrally connected by a side wall member 104c forming a channel 1105. The upper wall member 1104a and the lower wall member 1104b may be substantially parallel to each other. In one non-limiting example, the upper wall member 904a may have a width W1 and the lower wall member may have a width W2 where W2>W1.

The flange 1113 formed by the mating of the first attachment member 1102 to the back panel of the wireless module 1200 may be inserted into the channel 1105 of the second attachment member 1104 when assembling the flange mount clip fastener 1100.

The clip 1006 may be detachably or integrally connected to the second attachment member 1104. In one non-limiting example the clip 1106 may include a clip arm 1116 having to a bend portion and extending downwardly along the first attachment member 1104 when the clip fastener 1100 is in an assembled configuration. The clip arm 1116 may include a spring clip 1118 formed to bias against the first attachment member 1102. In use, an object or objects are inserted between clip arm 1116 and the first attachment member 1102. In one non-limiting example, the object may be a headband of a set of headphones, a belt or other clothing item allowing a user to attach or mount the wireless module. The spring clip 1118 may act to hold the object or objects between clip arm 916 and the first attachment member 1102. Those skilled in the art will appreciate that other types of clips and biasing mechanisms may also be used to hold an object or objects between clip arm 1116 and the first attachment member 1102.

Clip Fastener with Strap

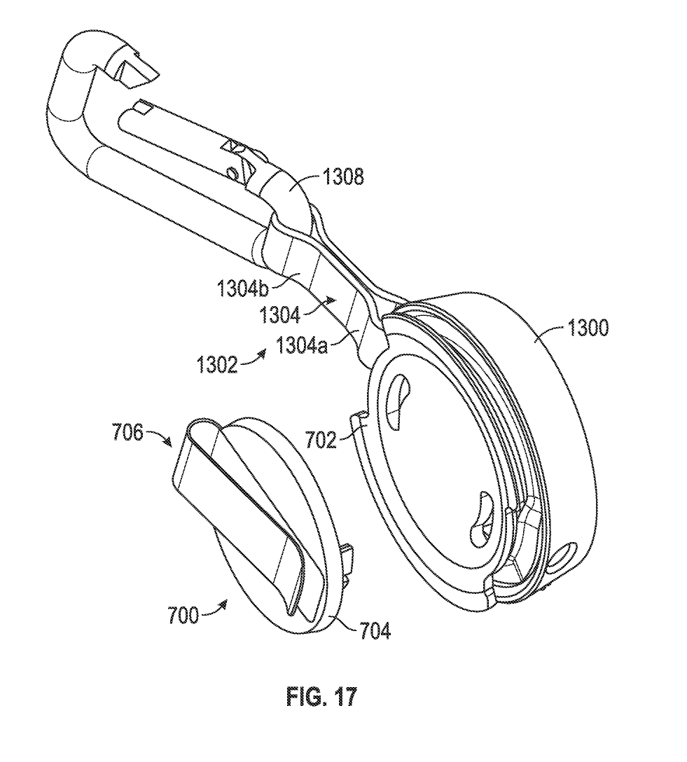

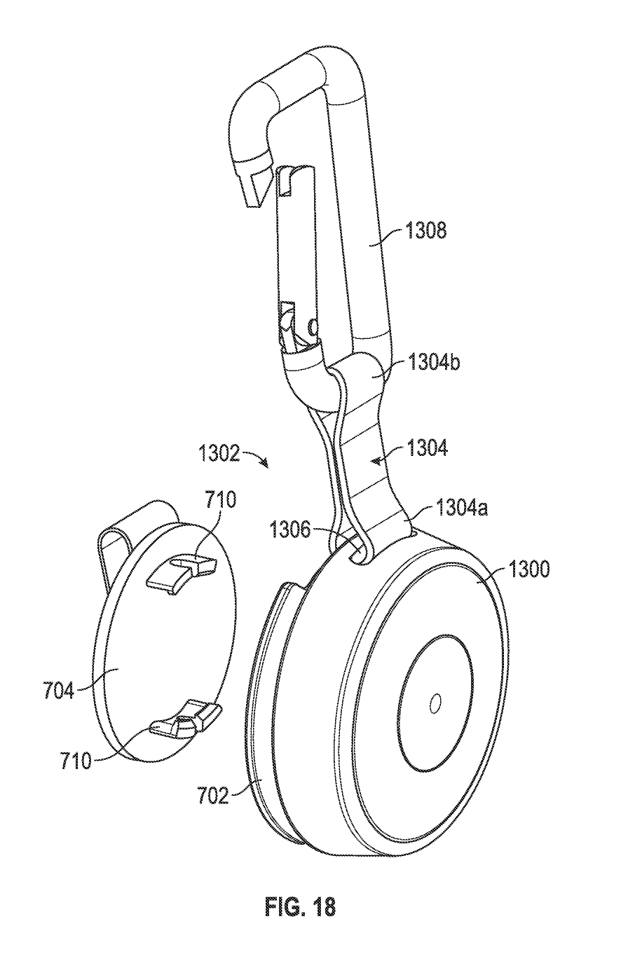

In another example, a clip fastener and/or a strap may be utilized for mounting or attaching a wireless module. FIG. 17 illustrates a left side perspective view of the clip fastener of FIG. 12 snapped onto a bottom panel of a wireless module having a strap assembly. FIG. 18 illustrates a right side perspective view of the clip fastener of FIG. 12 snapped onto a bottom panel of a wireless module having a strap assembly. Although the outer appearance of the wireless module 1300 in FIGS. 17-19 is different than the wireless module 100 in FIGS. 1-11, it may function in the same or similar way.

As shown, the wireless module 1300 may include a strap assembly 1302 for securing the wireless module 1300 to objects or other items. The strap assembly 1302 may include an elongated strap 1304 have a first end 1304a and a second end 1304b, the second end 1304b opposite the first end 1304a. The first strap end 1304a may be fixedly or removably attached to a strap opening 1306 located in the housing of the wireless module 1300. The second strap end 1304b may be fixedly or removably attached to an attaching member 1308, such as a carabiner, for securing the attaching member 1308 an object, such as a headband of a set of headphones, a belt, or a structure.

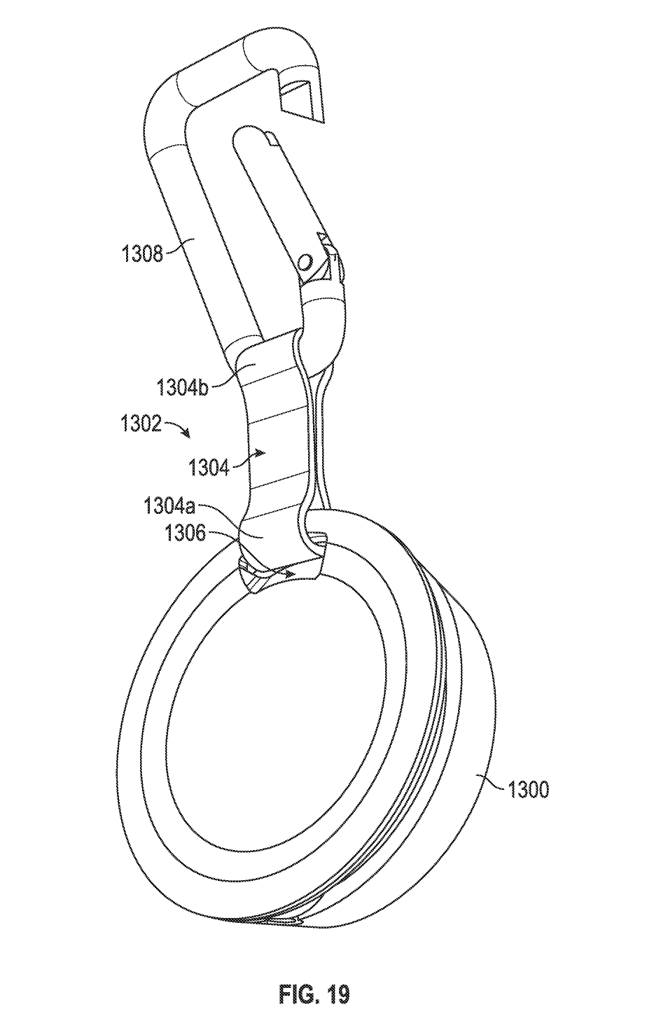

Alternatively, the wireless module 1300 may include the strap assembly 1302 without the clip fastener. FIG. 19 a left side perspective view of a wireless module having a strap assembly.

### Adjustable Strap Mount Fastener—Ratchet

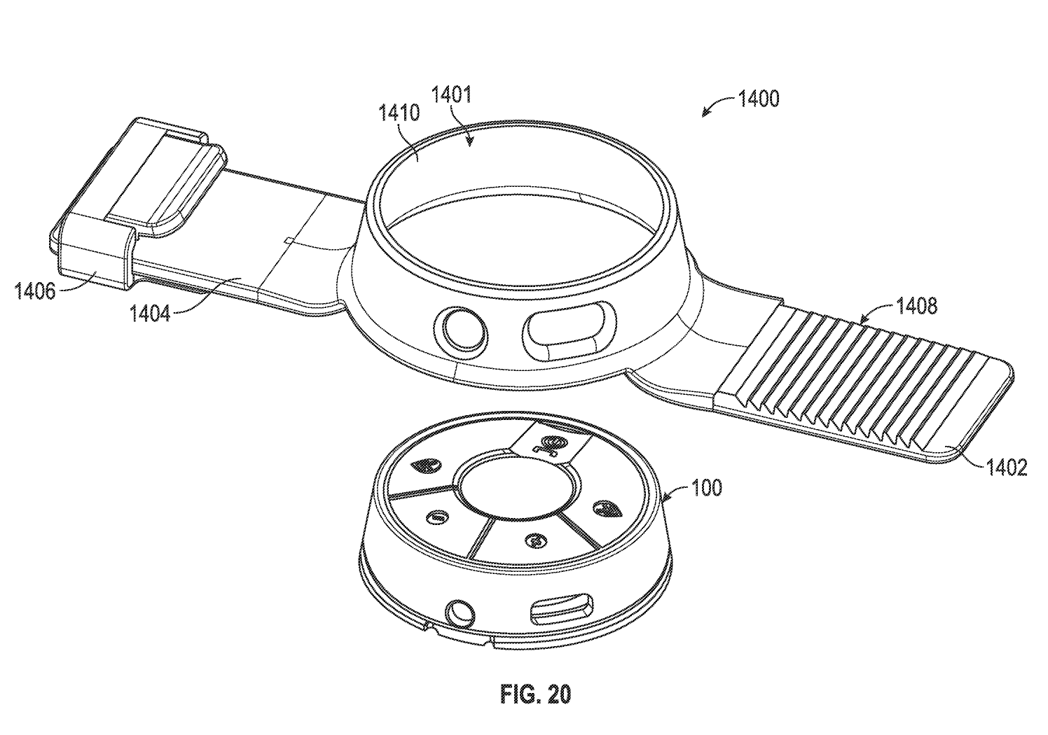

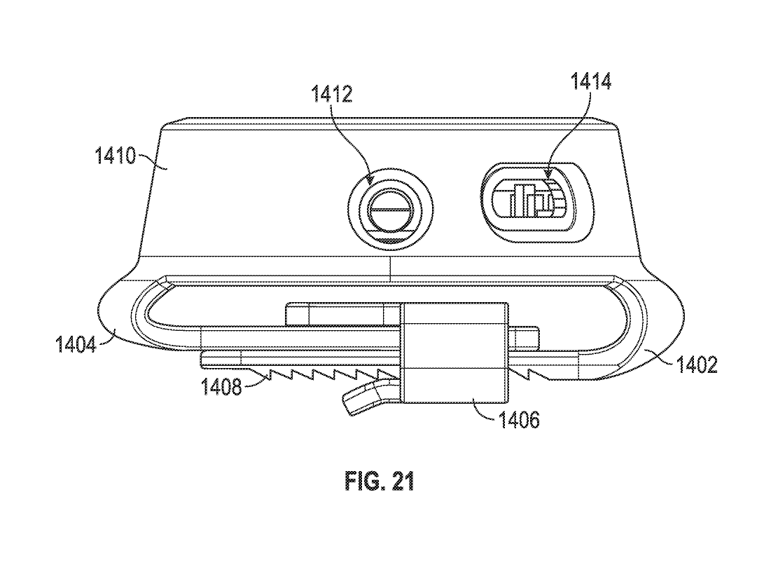

In one example, an adjustable strap mount fastener 1400, having a ratchet mechanism, may be utilized to mount a wireless module, such as the wireless module 100 as described above with reference to FIGS. 1-11. The adjustable strap mount fastener 1400 may be operable between an open position and a closed position. FIG. 20 illustrates an adjustable strap mount fastener 1400, having a ratchet mechanism, for mounting a wireless module 100, according to an aspect. FIG. 21 illustrates the adjustable strap mount fastener 1400 of FIG. 20 in a closed position. The adjustable strap mount fastener 1400 may be formed of a flexible material, such as plastic, rubber or metal, and configured to wrap around an object, such as a headband in a set of headphones.

As shown, the adjustable strap mount fastener 1400 may include a housing member (e.g., a ring) 1401 having a first strap 1402 and a second strap 1404 extending outwardly therefrom. The first strap 1402 may include a locking head 1406, having a passage or opening therethrough, formed on one end and detachably or fixedly attached to the housing member 1402 at the opposing end. The second strap 1404 may include spaced apart teeth 1408 formed in or on one side of one end of the strap and detachably or fixedly attached to the housing member 1402 at the opposing end. The locking head 1406 may be adapted to receive the teeth 1408 each of which have an inclined ramp surface to assist in a ratchet movement between the teeth and the locking head 1406 as known in the art.

The housing member 1402 may be formed of a generally circular wall member 1410 having a bottom opening for receiving the wireless module 100 and a top opening providing access to the user interface of the wireless module 100. Although the housing member 1402 is shown having a generally circular configuration, this is by way of example only and the housing member 1402 may be shaped and sized to receive the wireless module 100. Although the wireless module is shown as circular, this is by way of illustration only and the wireless module may take any shape.

The wall member 1410 may also include one or more side openings aligned with the interfaces on the wireless module 100. For example, the wall member 1410 may include a first side opening 1412 providing access to the audio cable interface 118 of the wireless module 100 and a second side opening 1414 providing access to the data/charging interface 120 of the wireless module 100.

As the first and second straps 1402, 1404 are formed of a flexible material, such as plastic, rubber or metal, they are configured to wrap around an object, such as a headband in a set of headphones.

Adjustable Strap Mount Fastener—Hook and Loop Fastener

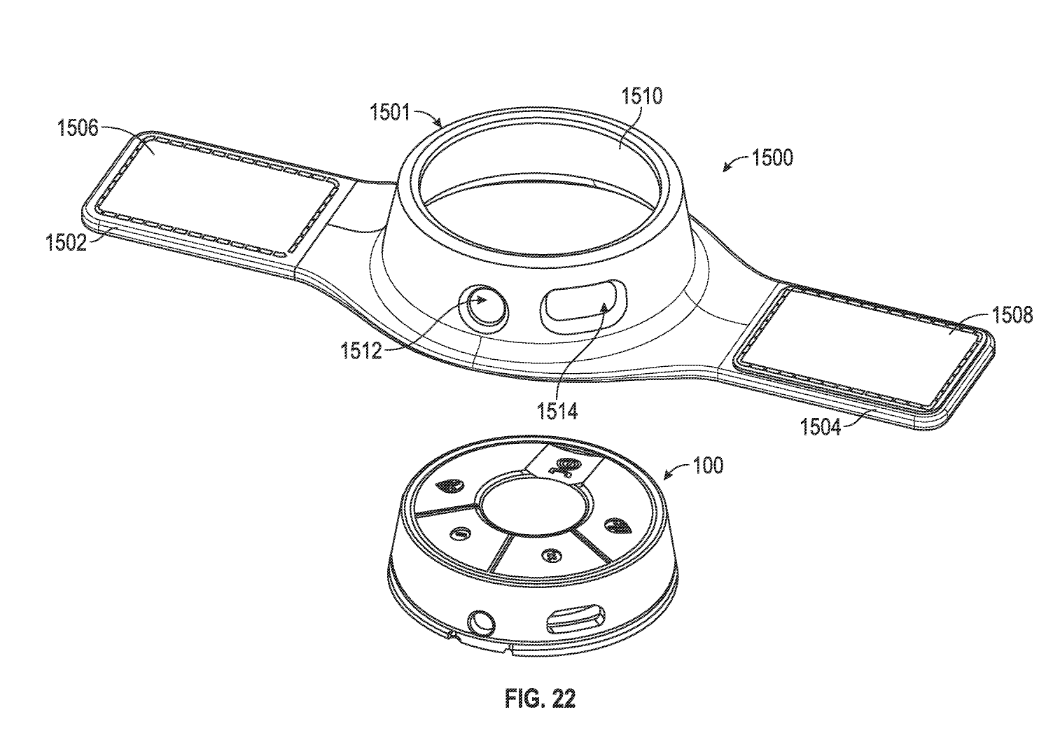

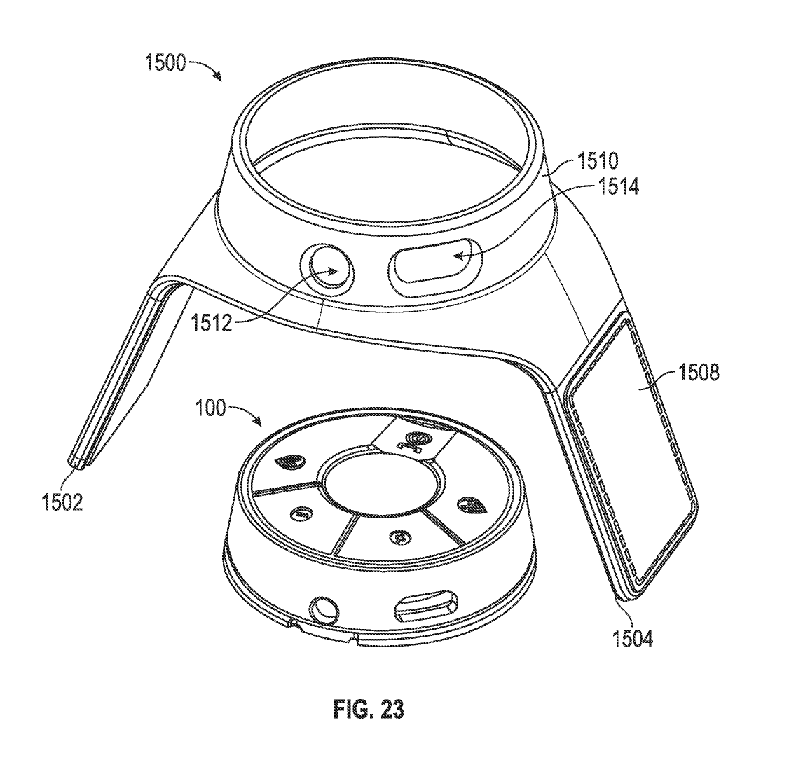

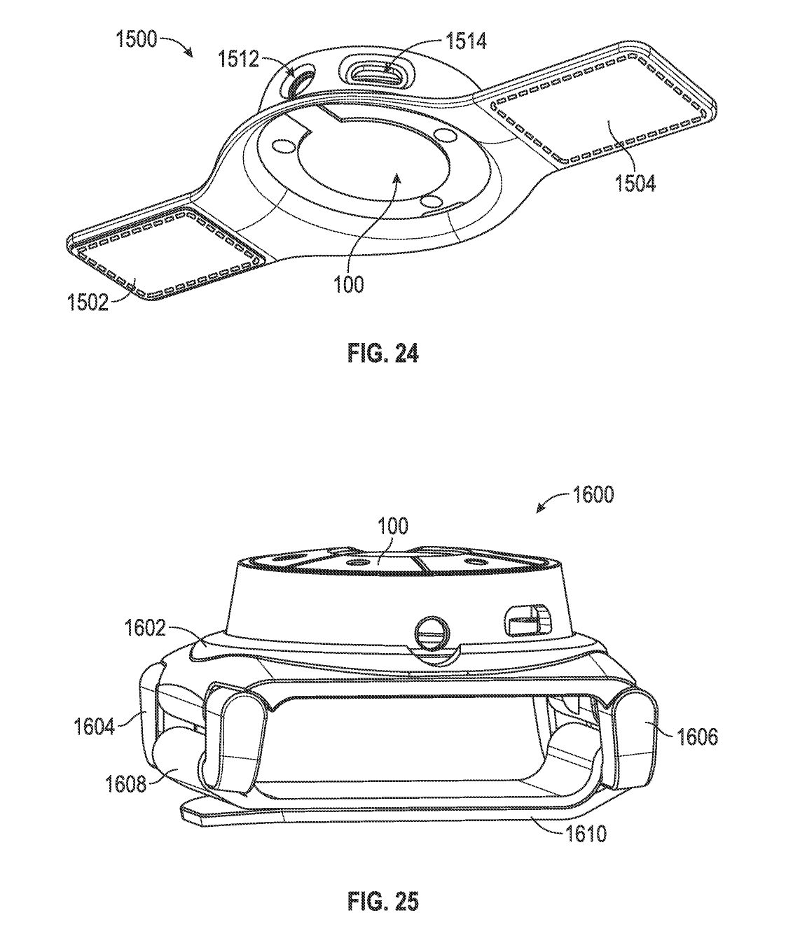

In one example, an adjustable strap mount fastener may be utilized to mount a wireless module, such as the wireless module 100 as described above with reference to FIGS. 1-11. FIG. 22 illustrates an adjustable strap mount fastener 1500 having a hook and loop fastener for mounting a wireless module 100, according to an aspect. FIG. 23 illustrates the adjustable strap mount fastener 1500 of FIG. 22 in a molded angled configuration. FIG. 24 illustrates a bottom perspective view the wireless module inserted into the adjustable strap mount fastener of FIG. 22. The adjustable strap mount fastener 1500 may be formed of a flexible material, such as plastic, rubber or metal, and configured to wrap around an object, such as a headband in a set of headphones.

As shown, the adjustable strap mount fastener 1500 may include a housing member 1501 having a first strap 1502 and a second strap 1504. The first strap 1502 may include a strip of hook elements 1506 adapted to be detachably coupled with a strip of loop elements 1508 on the second strap 1504. The strip of hook elements 1506 may be detachably coupled to any portion of the strip of loop elements 1508 providing for the mount fastener to be adjustable to the size of any object for which it is to be secured, such as a headband of a set of headphones. Although the strip of hook elements 1506 is described on the first strap 1502 and the strip of loop elements 1508 is described on the second strap 1504, this is by way of example only. The first strap 1502 may include hook elements and/or loop elements while the second strap 1504 may also include hook elements and/or loop elements.

The housing member 1501 may be formed of a generally circular wall member 1510 having a bottom opening for receiving the wireless module 100 and a top opening providing access to the user interface of the wireless module 100. Although the housing member 1501 is shown having a generally circular configuration, this is by way of example only and the housing member 1501 may be shaped and sized to receive the wireless module 100. Although the wireless module is shown as circular, this is by way of illustration only and the wireless module may take any shape.

The wall member 1510 may also include one or more side openings aligned with the interfaces on the wireless module 100. For example, the wall member 1510 may include a first side opening 1512 providing access to the audio cable interface 118 of the wireless module 100 and a second side opening 1514 providing access to the data/charging interface 120 of the wireless module 100.

The first and second straps 1502, 1504 of the adjustable strap mount fastener 1500 may have a generally straight configuration (i.e. the straps may extend approximately perpendicularly outward from the wall member 1510) as shown in FIGS. 22 and 24. Alternatively, the first and second straps 1502, 1504 of the adjustable strap mount fastener 1500 may have a generally angled configuration (i.e. the straps extend downwardly at an angle from the wall member 1510) as shown in FIG. 23.

As the first and second straps 1502, 1504 are formed of a flexible material, such as plastic, rubber or metal, they are configured to wrap around an object, such as a headband in a set of headphones.

### Pivotable Adjustable Strap Mount Fastener

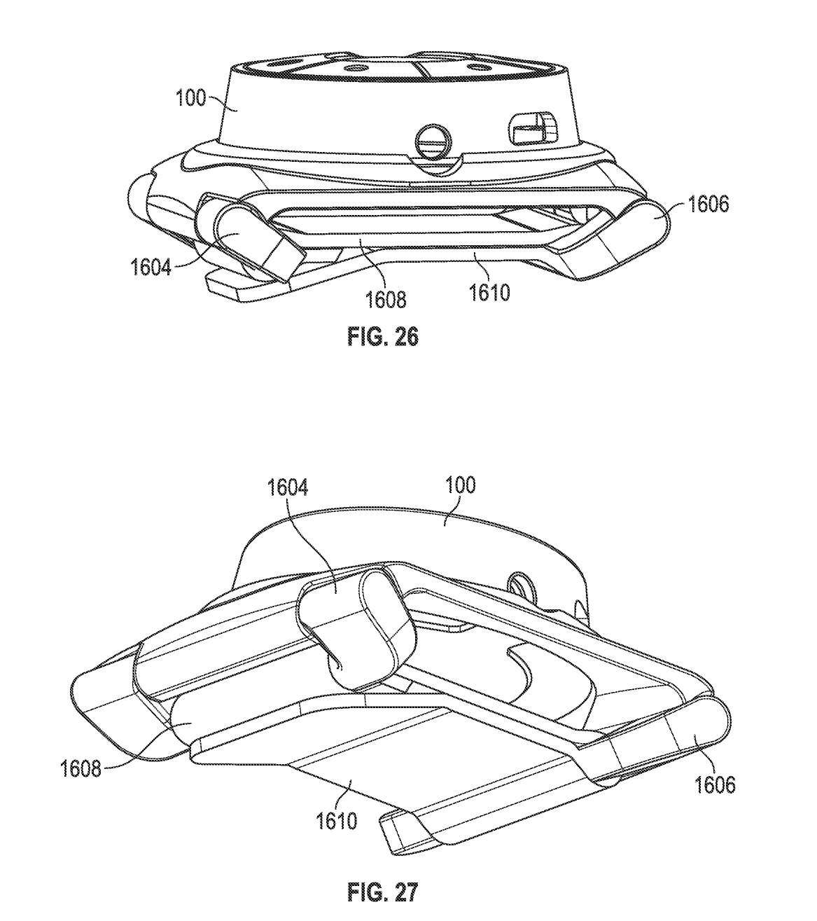

In one example, a pivotable adjustable strap mount fastener may be utilized to mount a wireless module, such as the wireless module 100 as described above with reference to FIGS. 1-11. FIG. 25 illustrates an adjustable strap mount fastener 1600 configured for enabling mounting of the wireless module 100 to large sized headband. FIG. 26 illustrates the adjustable strap mount fastener 1600 of FIG. 25 configured for enabling mounting of the wireless module 100 to small sized headband. FIG. 26 illustrates a bottom perspective view of the adjustable strap mount fastener 1600 of FIG. 25.

In various examples within the scope of the present disclosure, the pivotable adjustable strap mount fastener 1600 may include a housing (e.g., a ring) 1602 that secures the wireless module 100 to the headband in the same or a similar way as described above for the adjustable strap mount fastener of FIGS. 20-24. As illustrated, the pivotable adjustable strap mount fastener 1600 includes a first pivotable member 1604 and a second pivotable member 1606 for adapting to a large range of headband sizes.

A first strap 1608, having a first end and a second end, may be secured to the first pivotable member 1604 at the first end of the first strap 1608. A second strap 1610, having a first end and a second end, may be secured to the second pivotable member 1604 at the first end of the second strap 1610. Here, the pivotable members 1604, 1606 may be secured onto the housing 1602 of the pivotable adjustable strap mount fastener 1600 and pivotable between a range of positions. In this way, the housing 1602 may be placed against a headband and second end of the first strap 1608 may be selectively attached to the second end of the second strap 1610 by way of any suitable attachment apparatus, such as hook and loop, snaps, or clasps.

Together, these illustrations are intended to illustrate generally that the pivotable adjustable strap mount fastener 1600 may be utilized to fasten a wireless module 100 onto a range of different headband sizes, or onto a range of sizes of whatever apparatus a user may wish to fasten the wireless module onto.

In the illustrations herein, particularly FIGS. 5, 6, 9, and 10, the set of headphones onto which the wireless module 100 is mounted include a female audio connector, such that a short cable having two male connectors may be coupled between the wireless module 100 and the headphones. However, in some examples, headphones may include a cable with a male headphone jack, which is configured to be plugged into a female audio cable connector, e.g., in an audio player or mobile device. Therefore, in a further aspect of the disclosure, a fastener and/or a wireless module 100 may include a suitable cable management apparatus, e.g., wherein the cable may be wrapped around the cable management apparatus and the male end of the cable may be plugged into the interface at the wireless module 100. In this way, whether the headphones include a female audio connector, or a cable with a male audio connector, either a short cable between two female audio connectors, or a neatly wrapped cable between the headphones and the Bluetooth module 100, may provide a more “wireless” user experience, wherein the headphones may be utilized without having a cable to interfere with the user's freedom of motion.

By utilizing any of the fasteners described above, within the scope of the present disclosure, a user may be enabled to utilize any conventional set of headphones as wireless headphones. Furthermore, a user may be enabled to utilize any desired audio playback apparatus, not limited to headphones but also including a car stereo, a home stereo, etc., as a wireless audio playback apparatus simply by fastening the disclosed wireless module 100 to (or nearby) the audio playback apparatus and plugging in the audio cable interface as described.

In the foregoing specification, certain representative aspects of the invention have been described with reference to specific examples. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described. For example, the components and/or elements recited in any apparatus claims may be assembled or otherwise operationally configured in a variety of permutations and are accordingly not limited to the specific configuration recited in the claims.

Furthermore, certain benefits, other advantages and solutions to problems have been described above with regard to particular embodiments; however, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a nonexclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

Moreover, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. An apparatus for providing wireless transmission of audio content, comprising:
a wireless module, comprising:
a wireless transceiver configured for receiving an audio stream;
an audio output interface configured for sending an audio output stream; and
a fastener for fastening the wireless module transceiver to an audio playback apparatus.

2. The apparatus of claim 1, wherein the wireless module further comprises:
a housing; and
a bottom panel connected to the housing, the bottom panel having one or more male connectors extending horizontally outward from the bottom panel.

3. The apparatus of claim 2, wherein the fastener comprises:
a mounting base, the mounting base comprising:
a bottom surface having a pair of opposing mounting openings; and
a wall member extending perpendicularly upward from the bottom surface, the wall member comprising:
an inner surface and an opposing outer surface; and
one or more female connectors located on the inner surface of the wall member and adapted to receive the one or more male connectors of the wireless transceiver; and
a mounting strap, the mounting strap comprising:
a longitudinal strap having a first strap end and an opposing second strap end; and
a connecting member attached to the second strap end; and
wherein the first strap end is adapted to be received within the pair of opposing mounting openings and passed through the connecting member tightening the longitudinal strap.

4. The apparatus of claim 3, wherein the mounting base has a convex configuration.

5. The apparatus of claim 1, wherein the fastener comprises:
a metal plate adapted to be affixed to the audio playback device; and
one or more magnets affixed to the wireless module for securing the wireless module to the audio playback device by a magnetic force.

6. The apparatus of claim 3, wherein the metal plate includes a notch.

7. The apparatus of claim 1, wherein the wireless module further comprises:
a bottom panel having an outer surface and an opposing inner surface, the wireless transceiver secured to the inner surface of the bottom panel;
an internal panel, in electrical communication with the wireless transceiver, the audio output interface secured to the internal panel; and
a housing adapted to receive the internal panel and the bottom panel, the bottom panel configured to form a bottom of the housing.

8. The apparatus of claim 7, wherein the wireless module further comprises:
a user interface, in electrical communication with the audio output interface, for enabling audio playback functionality, wherein the user interface comprises a plurality of buttons.

9. The apparatus of claim 8, wherein the user interface is located on an outer surface of the housing.

10. The apparatus of claim 9, wherein the user interface is a tactile switch.

11. The apparatus of claim 1, wherein the audio playback device is a set of headphones.

12. An apparatus for providing wireless transmission of audio content, comprising:
a wireless module, comprising:
a bottom panel having an outer surface and an opposing inner surface;
a wireless transceiver, secured to the inner surface of the bottom panel, configured for receiving an audio stream;
an internal panel, in electrical communication with the wireless transceiver, having an audio output interface configured for sending an audio output stream; and
a housing adapted to receive the internal panel and the bottom panel, the bottom panel configured to form a bottom of the housing; and
a fastener for fastening the housing to an audio playback apparatus.

13. The apparatus of claim 1, wherein the bottom panel of the housing includes one or more male connectors extending horizontally outward from the bottom panel.

14. The apparatus of claim 13, wherein the fastener comprises:
a mounting base, the mounting base comprising:
a bottom surface having a pair of opposing mounting openings; and
a wall member extending perpendicularly upward from the bottom surface, the wall member comprising:
an inner surface and an opposing outer surface; and
one or more female connectors located on the inner surface of the wall member and adapted to receive the one or more male connectors of the wireless transceiver; and
a mounting strap, the mounting strap comprising:
a longitudinal strap having a first strap end and an opposing second strap end; and
a connecting member attached to the second strap end; and
wherein the first strap end is adapted to be received within the pair of opposing mounting openings and passed through the connecting member tightening the longitudinal strap.

15. The apparatus of claim 14, wherein the mounting base has a convex configuration.

16. The apparatus of claim 12, wherein the fastener comprises:
a metal plate adapted to be affixed to the audio playback device; and
one or more magnets affixed to the wireless transceiver for securing the wireless transceiver to the audio playback device by a magnetic force.

17. The apparatus of claim 16, wherein the metal plate includes a notch.

18. The apparatus of claim 12, wherein the wireless module further comprises:
a user interface, in electrical communication with the audio output interface, for enabling audio playback functionality, wherein the user interface comprises a plurality of buttons.

19. The apparatus of claim 18, wherein the user interface is a tactile switch.

20. The apparatus of claim 12, wherein the audio playback device is a set of headphones.
